(19) United States
(12) Patent Application Publication
(10) Pub. No.: US 2003/0159119 A1
(43) Pub. Date: Aug. 21, 2003

(54) Method for designing semiconductor integrated circuit and computing program for semiconductor integrated circuit

(75) Inventor: Yasuhide Sakanaka, Kanagawa (JP)

Correspondence Address: SUGHRUE MION, PLLC, 2100 PENNSYLVANIA AVENUE, N.W., WASHINGTON, DC, 20037, US

(73) Assignee: NEC ELECTRONICS CORPORATION

(21) Appl. No.: 10/359,094

(22) Filed: Feb. 6, 2003

(30) Foreign Application Priority Data
Feb. 20, 2002 (JP) 43913/2002

(51) Int. Cl. G06F 9/45; G06F 17/50

(52) U.S. Cl. 716/5

(57) ABSTRACT

A semiconductor integrated circuit designing method of the invention comprises (a) a step of determining the layout of a semiconductor integrated circuit, (b) a step of computing the computation value of a characteristic of the semiconductor integrated circuit, (c) a step of determining the margin of the characteristic on the basis of the layout, and (d) a step of detecting an error in the layout on the basis of the computation value and the margin. According to the semiconductor integrated circuit designing method, a margin is optimized by determining the margin according to the layout of a semiconductor integrated circuit and thereby the increase of the number of design man-hours to be caused by an excessive margin is prevented.

### BACKGROUND OF THE INVENTION

1. Field of the Invention

The present invention relates to a method for designing a semiconductor integrated circuit and a computing program for designing a semiconductor integrated circuit, and more particularly to a semiconductor integrated circuit designing method and a semiconductor integrated circuit designing program for designing a semiconductor integrated circuit as checking various characteristics of the semiconductor integrated circuit.

2. Description of the Prior Art

In commercialization of a semiconductor integrated circuit it is important to optimize the design of a semiconductor integrated circuit and its verification, and various semiconductor integrated circuit designing techniques and semiconductor integrated circuit verifying techniques have been developed.

In a semiconductor integrated circuit designing technique, the following matters are important.

First, it is important to design a semiconductor integrated circuit having excellent characteristics. For example, it is important to realize a high-speed operation, low power consumption and a small chip size.

Second, it is important to prevent an erroneous operation of a semiconductor integrated circuit designed. The verification of operation of a semiconductor integrated circuit is frequently performed in order to prevent an erroneous operation of the semiconductor integrated circuit. For example, to verify the timing of operation of a semiconductor integrated circuit or to check signal integrity is indispensable for designing a semiconductor integrated circuit correctly operating.

It is desirable to verify the operation timing of a semiconductor integrated circuit at a high accuracy, and a technique for performing a high-accuracy timing verification has been disclosed in Japanese Patent Laid-Open Publication No. Hei 7-98,727. Further, the optimization of operation timing of a semiconductor integrated circuit is important in order to prevent a semiconductor integrated circuit from erroneously operating. A semiconductor integrated circuit designing method for realizing the optimization of operation timing of a semiconductor integrated circuit has been disclosed in Japanese Patent Laid-Open Publication No. Hei 10-335,470.

Third, it is important to reduce the number of design steps for designing a semiconductor integrated circuit. To reduce the number of design steps for designing a semiconductor integrated circuit is important for shortening of TAT or reduction of cost, and studies of techniques for reducing the number of design steps for designing a semiconductor integrated circuit. For example, Japanese Patent Laid-Open Publication No. Hei 11-282,896 discloses a method of coping with a timing error for reducing the number of design steps for designing a semiconductor integrated circuit. The publicly known method of coping with a timing error generates an error list comprising the kind of an error and the result of checking a plurality of conditions related to the causes of the error.

Following this, a problem in a circuit is extracted by classifying the error on the basis of the error list. Next, an error correcting method is determined from the extracted problem. The publicly known method of coping with a timing error can clearly indicate the problem in a circuit and solve a timing error without relying on the intuition of a designer. Therefore, the publicly known method of coping with a timing error can reduce the number of design steps for designing a semiconductor integrated circuit. And other techniques related to reduction of the number of design steps for designing a semiconductor integrated circuit are disclosed in Japanese Patent Laid-Open Publication No.2000-156,414, Japanese Patent Laid-Open Publication No.2000-194,734, Japanese Patent Laid-Open Publication No.Hei 10-55,377, and Japanese Patent Laid-Open Publication No.Hei 6-4,613.

Furthermore, Japanese Patent Laid-Open Publication No.2000-20,567 discloses a technique for preventing that a timing error occurs again after a layout design is corrected for solving a timing error and thereby reducing the number of design steps for designing a semiconductor integrated circuit.

However, these three techniques have properties contrary to one another. For example, an erroneous operation of a semiconductor integrated circuit can be prevented by keeping a large margin. Whereas, an excessive margin results in deterioration of characteristics or increase of the number of design man-hours of a semiconductor integrated circuit. For example, in case that the margin of a holding time is determined to be excessive, the need of adding an originally unnecessary cell to a semiconductor integrated circuit occurs in order to secure the margin.

The addition of an unnecessary cell may lead to deterioration in characteristics of a semiconductor integrated circuit. For example, the addition of an unnecessary cell increases a delay time, enlarges the size of a chip and increases the power consumption. Moreover, to secure the margin needs to modify the layout patern of a semiconductor integrated circuit and results in increasing the number of design man-hours of the semiconductor integrated circuit.

It is desired to realize the improvement of characteristics of a semiconductor integrated circuit, the prevention of an erroneous operation of the semiconductor integrated circuit and the reduction of design man-hours of the semiconductor integrated circuit at the same time.

### SUMMARY OF THE INVENTION

An object of the present invention is to provide a technique for designing a semiconductor integrated circuit, the technique being capable of reducing the number of design man-hours as preventing an erroneous operation of the designed semiconductor integrated circuit.

Another object of the present invention is to provide a technique for designing a semiconductor integrated circuit having excellent characteristics, the technique being capable of reducing the number of design man-hours as preventing an erroneous operation of the designed semiconductor integrated circuit. The present invention particularly aims at providing a technique for designing a semiconductor integrated circuit, the technique being capable of reducing the power consumption and the chip size of it.

Next, the correspondence relation between claims and embodiments of the invention is clarified using numbers and symbols used in the embodiments of the invention. These numbers and symbols are provided in order to clarify the correspondence relation between the claims and the embodiments.

A semiconductor integrated circuit designing method according to the present invention comprises;

a step (S05) of determining the layout patern of a semiconductor integrated circuit (10),

a step (S10-1) of computing a computation value (thold) of a characteristic of the semiconductor integrated circuit (10),

a step (S10-2) of determining the margin (tm) of the characteristic on the basis of the layout patern, and

a step (S10-3) of detecting an error in the layout patern on the basis of the computation value (thold) and the margin (tm). In the semiconductor integrated circuit designing method, a margin (tm) is optimized by determining the margin according to the layout patern of a semiconductor integrated circuit and the increase in number of design man-hours to be caused by an excessive margin is prevented.

It is preferable that the above-mentioned characteristic is the holding time of a register (17) contained in the semiconductor integrated circuit (10). In case that an excessive margin is determined for the holding time, an unnecessarily large number of cells need to be added to a semiconductor integrated circuit in order to satisfy this margin. By optimizing the margin of a holding time, an unnecessary addition of cells is prevented and the reduction of chip area and power consumption of a semiconductor integrated circuit is made possible.

It is preferable that the margin of a holding time (tm) is determined on the basis of the width of wiring for transmitting a signal to a register (17).

And it is preferable that the margin of a holding time (tm) is determined on the basis of the spacing between the wiring for transmitting a signal to a register (17) and another wiring contained in the semiconductor integrated circuit (10).

And it is preferable that the margin of a holding time (tm) is determined on the basis of the shielding ratio of the wiring for transmitting a signal to a register (17).

And a semiconductor integrated circuit designing method according to the present invention preferably comprises;

a net list-making step (S02) of making a net list of a semiconductor integrated circuit,

a first check step (S03) of performing a first signal integrity check of the semiconductor integrated circuit on the basis of the net list, and

a step (S05) of making a layout patern of the semiconductor integrated circuit on the basis of the net list after the first check step (S03). In the semiconductor integrated circuit designing method, a signal integrity check is performed at the upper stream of a design process and thereby the number of design man-hours can be reduced.

The first check step (S03) preferably comprises;

a fan-out acquiring step of acquiring the number of fan-outs of each of cells contained in the semiconductor integrated circuit on the basis of the net list, and

a second check step of performing the first signal integrity check on the basis of the number of fan-outs.

The semiconductor integrated circuit designing method preferably further comprises a step (S07) of performing a second signal integrity check on the basis of the layout patern after the step (S05).

The net list-making step (S02) is preferably performed without estimating the holding time of an element contained in the semiconductor integrated circuit.

And a semiconductor integrated circuit designing method according to the present invention comprises;

a step (S05) of determining a first layout patern of a semiconductor integrated circuit, a first layout correcting step (S06 to S09) of making a second layout patern through correcting the first layout patern so as to solve a setup time violation of a semiconductor integrated circuit and a signal integrity violation of the semiconductor integrated circuit, and

a second layout-correcting step (S08 to S10) of correcting the second layout patern so as to solve a holding time violation of the semiconductor integrated circuit after the first layout-correcting step.

At this time, the second layout-correcting step (S08 to S10) preferably comprises;

a holding time margin-determining step (S10-1) of determining the margin (tm) of a holding time on the basis of the second layout patern,

a holding time computing step of computing the computation value (thold) of a holding time, and

a holding time violation-detecting step of detecting a holding time violation of the second layout patern on the basis of the computation value (thold) and the margin (tm).

And a program for designing a semiconductor integrated circuit according to the present invention makes a computer (24) perform;

a step (S05) of determining the layout patern of a semiconductor integrated circuit (10),

a step (S10-1) of computing a computation value (thold) of a characteristic of the semiconductor integrated circuit (10),

a step (S10-2) of determining the margin (tm) of the characteristic on the basis of the layout patern, and

a step (S10-3) of detecting an error in the layout patern on the basis of the computation value (thold) and the margin (tm).

And a program for designing a semiconductor integrated circuit according to the present invention makes a computer (24) perform;

a net list-making step (S02) of making a net list of a semiconductor integrated circuit,

a first check step (S03) of performing a first signal integrity check of the semiconductor integrated circuit on the basis of the net list, and

a step (S05) of making a layout patern of the semiconductor integrated circuit on the basis of the net list after the first check step (S03).

And a program for designing a semiconductor integrated circuit according to the present invention makes a computer (24) perform;

a step (S05) of determining a first layout patern of a semiconductor integrated circuit,

a first layout correcting step (S06 to S09) of making a second layout patern through correcting the first layout patern so as to solve a setup time violation of the semiconductor integrated circuit and a signal integrity violation of the semiconductor integrated circuit, and

a second layout-correcting step (S08 to S10) of correcting the second layout patern so as to solve a holding time violation of the semiconductor integrated circuit after the first layout-correcting step.

### BRIEF DESCRIPTION OF THE DRAWINGS

FIG. 1 is a flowchart showing an embodiment of a semiconductor integrated circuit designing method according to the present invention.

FIG. 2 is a diagram for explaining a concrete example of a holding time check.

FIG. 3 is a diagram showing an example of a design apparatus to be used in an embodiment of a semiconductor integrated circuit designing method according to the present invention.

### DETAILED DESCRIPTION OF THE PREFERRED EMBODIMENTS

Next, an embodiment of a semiconductor integrated circuit designing method according to the present invention is described with reference to the accompanying drawings.

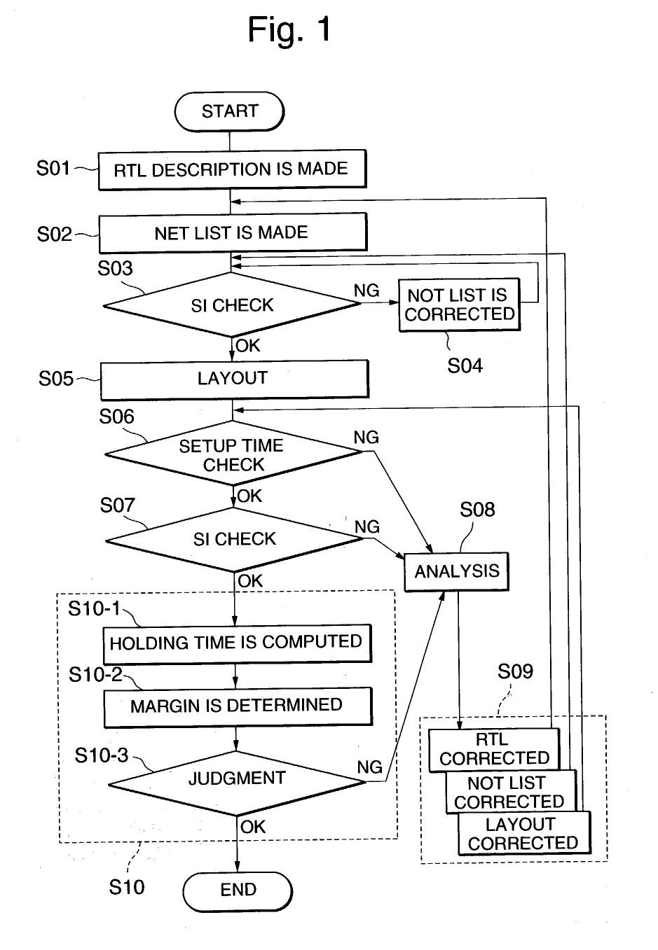

FIG. 1 shows a design process performed by an embodiment of a semiconductor integrated circuit designing method according to the present invention. In this embodiment, first a logic design is performed and a description in RTL (Register Transfer Level) (hereinafter referred to as “RTL description”) of a semiconductor integrated circuit to be designed is prepared (step S01).

Subsequently, a circuit design is performed, and a net list of the semiconductor integrated circuit is made from the prepared RTL description (step S02). The mutual connection relation between cells is described in the net list.

In making the net list, no estimation of a holding time is performed and no measure for properly securing a holding time is taken. In order to secure a holding time, a cell is generally added, but even if a cell for securing a holding time is added when making a net list, it is difficult to properly make a circuit. Thus, in order to prevent the addition of an unnecessary cell, no adjustment of a holding time is performed at the stage of making a net list.

Following this, a signal integrity check of the semiconductor integrated circuit is performed on the basis of the prepared net list (step S03). In case that a signal integrity violation is detected by the signal integrity check, the net list is corrected (step S04), and a signal integrity check is performed again (S03). The correction of the net list in step S04 and the signal integrity check in step S03 are repeated until no signal integrity violation is detected.

The signal integrity check in step S03 is performed on the basis of the number of fan-outs of a cell contained in the semiconductor integrated circuit. The number of fan-outs of a cell contained in the semiconductor integrated circuit is detected on the basis of the prepared net list and if the number of fan-outs of a cell exceeds a specified number, it is judged that there is a signal integrity violation. A signal integrity check in step S03 is performed before the layout design of a semiconductor integrated circuit is determined, and this signal integrity check cannot use a parameter depending on the layout patern such as a wiring capacity and the like.

However, the number of fan-outs of each cell has been determined before step S03. If the number of fan-outs is excessive, a signal integrity violation occurs regardless of a wiring capacity. Thereupon, a signal integrity check based on the number of fan-outs is performed in step S03, and a design check is performed at a more upstream point of a design flow. To check a design at the upstream point of a design flow is preferable from the viewpoint of reducing the number of correction man-hours.

After no signal integrity violation has come to be found in the net list in a signal integrity check in step S03, a layout design of the semiconductor integrated circuit is made from the net list (step S05). The layout patern infomatin made from step S05 has the arrangement of cells and the arrangement of wiring described in it.

Subsequently, a back annotation of the layout patern is performed (on and after step S06).

In the back annotation, a setup time check (step S06) and a signal integrity check (step S07) are first performed.

In the setup time check (step S06), it is checked whether or not there is a setup time violation of each register (flip-flop) contained in the semiconductor integrated circuit. In the signal integrity check (step S07), it is checked whether or not there is a signal integrity violation in each node (wiring) contained in the semiconductor integrated circuit. In the signal integrity check, it is checked whether or not the capacity of each node of the semiconductor integrated circuit and the rise and fall gradients of the waveform of a signal transmitted through the node are within a standard range.

In this embodiment, the margin of a setup time is equally determined for each register and the margin of signal integrity is equally determined for each node. It is optional which is performed earlier, the setup time check (step S06) or the signal integrity check (step S07).

In case that a setup time violation and/or a signal integrity violation are found in a setup time check (step S06) and a signal integrity check (step S07), a cause of it is analyzed (step S08). Which is to be corrected among the RTL description, the net list and the layout patern are made clear by the analysis. According to the result of the analysis, some of the RTL description, the net list and the layout patern are selectively corrected (step S09). The design process is returned to step S02 in case of correcting the RTL description, is returned to step S03 in case of correcting the net list, and is returned to step S06 in case of correcting the layout patern. By the above-described process, a layout patern in which a setup time violation and/or a signal integrity violation are not found is made.

After a layout patern in which a setup time violation and/or a signal integrity violation are not found is made, a holding time check is performed (step S10).

A holding time check (step S10) is performed as follows. First, the holding time of each register contained in a semiconductor integrated circuit is computed (step S10-1). Following this, for each register a margin to be imposed on the holding time of it is determined (step S10-2). The margin of a holding time is determined variably for each register according to the layout patern of a path through which a signal is supplied to a register with reference to a layout patern determined in the above-described steps Sol to S09 in which a setup time violation and/or a signal integrity violation are not found. Subsequently, it is judged whether or not the holding time of each register is larger than a specified margin, and it is detected whether or not there is a holding time violation (step S10-3).

A fact that the margin of a holding time determined in step S10-2 is variable makes it possible to prevent an excessive margin of a holding time as securing a necessary margin and preventing an erroneous operation of a semiconductor integrated circuit. In case of equally determining the margin of a holding time for every register, the margin needs to be determined, large adaptively to a register needing a large margin, and the determined margin is liable to be an excessive margin. When an excessively large margin is determined, many holding time violations occur and unnecessary layout patern correction is forced in order to solve the margin. Such an unnecessary layout patern correction increases the number of design man-hours. Further, in order to satisfy such an excessive margin, unnecessary addition of cells is forced and the chip size and the power consumption of a designed semiconductor integrated circuit are increased. In this embodiment, an excessive margin is prevented in that the margin of a holding time is variably determined according to the layout patern. Thanks to this, it is possible to reduce the number of design man-hours, the chip size and the power consumption.

At this time, it is effective for more reducing the number of design man-hours that a holding time check making the margin of a holding time variable is performed after a layout patern in which a setup time violation and/or a signal integrity violation are not found is made. The number of points to be corrected in a layout patern for solving a holding time violation is reduced by performing a holding time check as making the margin of a holding time variable. Thanks to a fact that the number of points to be corrected in a layout patern is small, a setup time violation and a signal integrity violation to be caused by correction of the layout patern are made to be hard to occur.

Therefore, a setup time violation resulted from layout patern-corrections to eliminate holding time violation, and layout patern-corrections to eliminate a signal integrity violation are also reduced. In such a way, the number of design man-hours is synergically reduced by a fact that a holding time check making the margin of a holding time variable is made after a layout patern in which a setup time violation and/or a signal integrity violation are not found is made.

A margin to be imposed on a holding time is preferably determined on the basis of at least one of;

(1) the width of wiring contained in a path for supplying a signal to a register, and

(2) the spacing between the wiring contained in the path for supplying a signal to the register and another wiring (not illustrated) contained in a semiconductor integrated circuit. The degree of variation in delay time in wiring depends on the width of wiring and the spacing between wirings. The smaller the wiring width is and the narrower the wiring spacing is, the larger the variation (the range of fluctuation) in delay time in wiring is. A large margin is needed in case that variation in delay time is large, and a large margin is not needed in case that variation in delay time is small. Accordingly, a margin can be optimized by determining the margin on the basis of the width of wiring contained in a path for supplying a signal to a register and the spacing between the wiring contained in the path for supplying a signal to the register and another wiring (not illustrated) contained in the semiconductor integrated circuit.

And the margin of a holding time is preferably determined on the basis of the shielding ratio of wiring contained in a path for supplying a signal to a register. The shielding ratio of wiring contained in a path for supplying a signal to a register is the ratio of a part of wiring shielded by a wiring whose electric potential is fixed (for example, a power supply line and a grounding line) to the whole wiring. In case that the shielding ratio is large, a large margin is not necessary. A margin can be optimized by being determined on the basis of the shielding ratio of wiring.

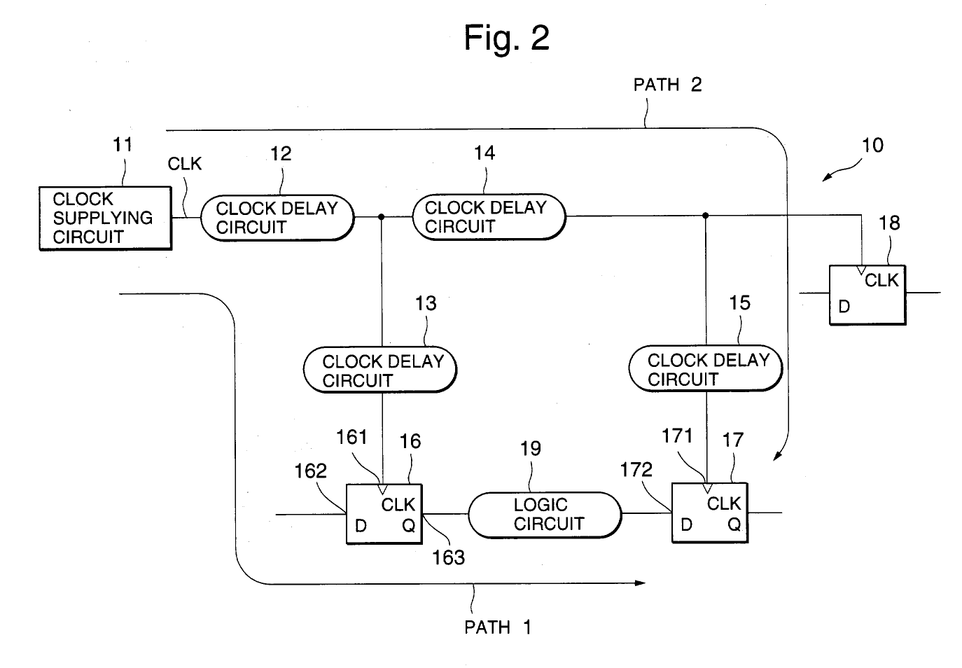

A holding time check of a register 17 contained in a semiconductor integrated circuit 10 shown in FIG. 2 is described as an example of a holding time check (step S10). The semiconductor integrated circuit 10 comprises a clock supplying circuit 11, clock delay circuits 12 to 15, registers 16 to 18 and a logic circuit 19. A clock signal CLK generated by the clock supplying circuit 11 is inputted to a clock terminal 161 of a register 16 through clock delay circuits 12 and 13. The register 16 latches data inputted to a data terminal 162 synchronously with the clock signal CLK inputted to the clock terminal 161, and outputs the latched data through an output terminal 163. A logic operation is performed by the logic circuit 19 on the data outputted from the output terminal 163, and the operated data is supplied to a data terminal 172 of a register 17. On the other hand, a clock signal 21 is supplied to a clock terminal 171 of the register 17 through the clock delay circuits 12, 14 and 15. The register 17 latches the operated data inputted to the data terminal 172 from the logic circuit 19 synchronously with the clock signal 21 inputted to the clock terminal 171. First, the holding time thold of the register 17 is computed (step 10-1). The holding time thold is computed by the following expression:

thold=t1−t2,

where t1 is a delay time of a path 1 reaching the data terminal 172 of the register 17 from the clock supplying circuit 11 through the clock delay circuits 12 and 13, the register 16 and the logic circuit 19, and t2 is a delay time of a path 2 reaching the clock terminal 171 of the register 17 from the clock supplying circuit 11 through the clock delay circuits 12, 14 and 15.

Following this, a margin tm to be imposed on the holding time of the register 17 (step S10-2). In more detail, first a margin ratio rm is determined. The product of the delay time t2 of the path 2 being a path for supplying a clock signal to a register and the margin ratio rm is determined as the margin tm. For example, when the margin ratio rm is 10% and the delay time t2 of the path 2 is 1 (ns), the margin tm is 0.1 (ns).

The margin ratio rm is determined on the basis of the layout patern of the paths 1 and 2. The margin ratio rm of the register 17 is determined on the basis of at least one item of (1) the widths of wirings contained in the paths 1 and 2 for supplying signals to the register 17, (2) the spaces between the wirings provided in the paths 1, 2 and other wirings (not illustrated) contained in the semiconductor integrated circuit, and (3) the shielding ratios of wirings provided in the paths 1 and 2. This optimizes the margin tm.

After the margin tm has been determined, it is judged whether or not there is a holding time violation of the register 17.

When thold=t1−t2≧tm,

it is judged that there is no holding time violation of the register 17. The holding time check of the register 17 is finished with the aforementioned operations. A holding time check is also performed in a similar way for another register contained in the semiconductor integrated circuit.

In case that a holding time violation is found in the layout patern of a semiconductor integrated circuit to be designed, a cause of it is analyzed (step S08), and which is to be corrected among the RTL description, the net list and the layout patern is made clear by the analysis. According to the result of the analysis, some of the RTL description, the net list and the layout patern are selectively corrected (step S09). The design process is returned to step S02 in case of correcting the RTL description, is returned to step S03 in case of correcting the net list, and is returned to step S06 in case of correcting the layout patern.

The RTL description, the net list and the layout patern are corrected until a holding time violation is solved. Finally, a layout patern in which a setup time violation, a signal integrity violation and a holding time violation are not found is made and the design process is finished.

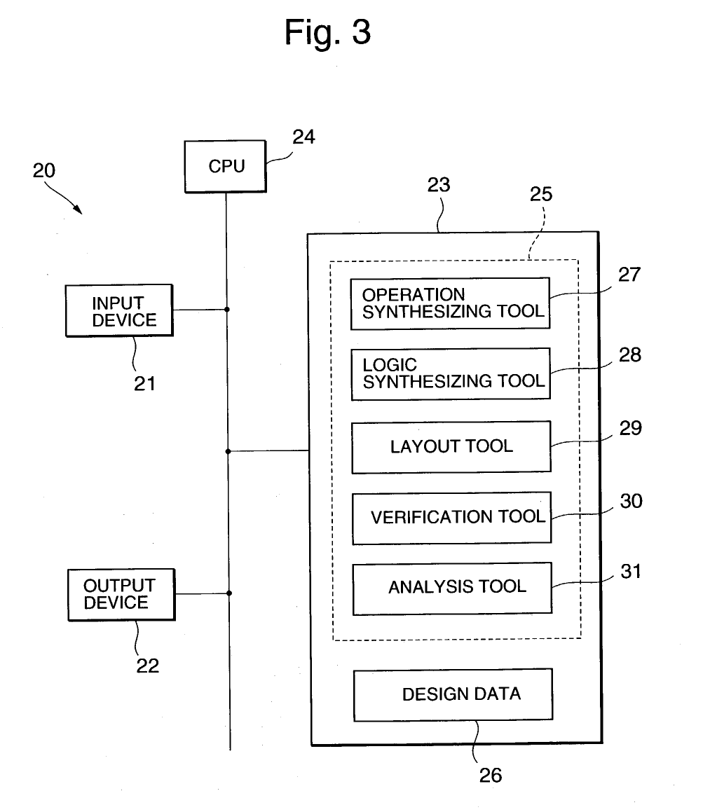

FIG. 3 shows an example of a design apparatus 20 for performing a semiconductor integrated circuit designing method as described above. The design apparatus 20 comprises an input device 21, an output device 22, a storage device 23 and a central processing unit (CPU) 24. The input device 21 and the output device 22 are man-machine interfaces for operating the design apparatus 20. The input device 21 comprises a keyboard and a mouse for example, and the output device 22 comprises a cathode ray tube (CRT) and a printer. The storage device 23 stores a design program 25 and design data 26 in it. The design program 25 is a software program for providing a design environment of a semiconductor integrated circuit to a user, and the design of a semiconductor integrated circuit is performed by performing the design program 25 by means of the CPU 24. The design data 26 comprises various data generated in the aforementioned design process such as the aforementioned RTL descriptions, net lists and layout paterns for example.

The design program 25 comprises an operation-synthesizing tool 27, a logic-synthesizing tool 28, a layout design tool 29, a verification tool 30 and an analysis tool 31. The operation-synthesizing tool 27 is software for producing an RTL description by performing the aforementioned step S01. The logic-synthesizing tool 28 is software for producing a net list by performing the aforementioned step S02. The layout design tool 29 is software for producing a layout patern by performing the aforementioned step S05. The verification tool 30 is software for performing a signal integrity check (step S03, S07), a setup time check (step S06) and a holding time check (step S10) as described above. The analysis tool 31 is software for analyzing causes of various violations and correcting an RTL description, a net list and a layout patern by performing steps S04, S08 and S09 as described above. A design process as described above is performed by performing the design program 25 having such a composition by means of the CPU 24.

As described above, in a semiconductor integrated circuit designing method of this embodiment, the margin of a holding time is made variable according to the layout patern of a path for supplying a signal to a register. Thanks to this, the margin of a holding time is properly determined to realize the prevention of occurrence of an excessive margin as preventing an erroneous operation of a semiconductor integrated circuit. Thanks to the prevention of occurrence of an excessive margin, it is possible to reduce the number of design man-hours, the chip size and the power consumption of a semiconductor integrated circuit designed.

Further, in a semiconductor integrated circuit designing method of this embodiment, a signal integrity check of a semiconductor integrated circuit is performed on the basis of a net list, and furthermore a signal integrity check of the semiconductor integrated circuit is performed on the basis of a layout patern made from the net list. This realizes a secure guarantee of signal integrity and the number of design man-hours of a semiconductor integrated circuit can be reduced by solving a signal integrity violation at the upper stream of a design process.

In this embodiment, also with regard to other check items than a holding time, for example, with regard to a setup time and signal integrity, margins of them can be variably determined according to their layout paterns. A fact that a margin is variable in such a way is preferable in preventing an excessive margin and reducing the number of design man-hours.

A fact that the margin of a holding time is variable is more effective in that the effect of reduction in chip size and power consumption is great. Securing the margin of a holding time is generally performed by adding a cell for delaying a signal. A fact that the margin of a holding time is variable according to a layout patern makes it possible to suppress addition of an unnecessary cell for securing the margin of a holding time and reduce the chip size and the power consumption.

According to the present invention, there is provided a technique for designing a semiconductor integrated circuit capable of reducing the number of design man-hours as preventing an erroneous operation of a semiconductor integrated circuit designed.

Furthermore, according to the present invention, there is provided a technique for designing a semiconductor integrated circuit having excellent characteristics capable of reducing the number of design man-hours as preventing an erroneous operation of a semiconductor integrated circuit designed. Particularly, there is provided a design technique for making small the chip size and the power consumption as preventing an erroneous operation of a semiconductor integrated circuit designed.

What is claimed is:

1. A method for designing a semiconductor integrated circuit comprising;
a first layout step of determining a layout patern of a semiconductor integrated circuit,
a characteristic computation value-computing step of computing the computation value of a characteristic of said semiconductor integrated circuit,
a margin determining step of determining the margin of said characteristic on the basis of said layout patern, and
a layout error-detecting step of detecting an error in said layout patern on the basis of said computation value and said margin.

2. The method for designing a semiconductor integrated circuit according to claim 1, wherein;
said characteristic is the holding time of a register contained in said semiconductor integrated circuit.

3. The method for designing a semiconductor integrated circuit according to claim 2, wherein;
said margin is determined on the basis of the width of wiring for transmitting a signal to said register.

4. The method for designing a semiconductor integrated circuit according to claim 2, wherein;
said margin is determined on the basis of the space between the wiring for transmitting a signal to said register and another wiring contained in said semiconductor integrated circuit.

5. The method for designing a semiconductor integrated circuit according to claim 2, wherein;
said margin is determined on the basis of the shielding ratio of wiring for transmitting a signal to said register.

6. A method for designing a semiconductor integrated circuit comprising;
a net list-making step of making a net list of a semiconductor integrated circuit,
a first check step of performing a first signal integrity check of said semiconductor integrated circuit on the basis of said net list, and
a second layout step of making a layout patern of said semiconductor integrated circuit on the basis of said net list after said first check step.

7. The method for designing a semiconductor integrated circuit according to claim 6, wherein;
said first check step comprises;
a fan-out acquiring step of acquiring the number of fan-outs of each cell contained in said semiconductor integrated circuit on the basis of said net list, and
a second check step of performing said first signal integrity check on the basis of said number of fan-outs.

8. The method for designing a semiconductor integrated circuit according to claim 6, further comprising;
a third check step of performing a second signal integrity check on the basis of said layout patern after said second layout step.

9. The method for designing a semiconductor integrated circuit according to claim 6, wherein;
said net list making step is performed without estimating the holding time of an element contained in said semiconductor integrated circuit.

10. A method for designing a semiconductor integrated circuit comprising;
a third layout step of determining a first layout patern of a semiconductor integrated circuit,
a first layout correcting step of making a second layout patern by correcting said first layout patern so as to solve a setup time violation of said semiconductor integrated circuit and a signal integrity violation of said semiconductor integrated circuit, and
a second layout-correcting step of correcting said second layout patern so as to solve a holding time violation of said semiconductor integrated circuit after said first layout correcting step.

11. The method for designing a semiconductor integrated circuit according to claim 10, wherein;
said second layout correcting step comprises;
a margin-determining step of determining the margin of said holding time on the basis of said second layout patern,
a holding time computing step of computing the computation value of said holding time, and
a holding time violation detecting step of detecting a holding time violation of said second layout patern on the basis of said computation value and said margin.

12. A computing program for designing a semiconductor integrated circuit comprising;
a first layout step of determining a layout patern of a semiconductor integrated circuit,
a characteristic computation value-computing step of computing the computation value of a characteristic of said semiconductor integrated circuit,
a margin determining step of determining the margin of said characteristic on the basis of said layout patern, and
a layout error-detecting step of detecting an error in said layout patern on the basis of said computation value and said margin.

13. A computing program for designing a semiconductor integrated circuit comprising;
a net list-making step of making a net list of a semiconductor integrated circuit,
a first check step of performing a first signal integrity check of said semiconductor integrated circuit on the basis of said net list, and
a second layout step of making a layout patern of said semiconductor integrated circuit on the basis of said net list after said first check step.

14. A computing program for designing a semiconductor integrated circuit comprising;
a third layout step of determining a first layout patern of a semiconductor integrated circuit,
a first layout correcting step of making a second layout patern by correcting said first layout patern so as to solve a setup time violation of said semiconductor integrated circuit and a signal integrity violation of said semiconductor integrated circuit, and
a second layout-correcting step of correcting said second layout patern so as to solve a holding time violation of said semiconductor integrated circuit after said first layout correcting step.

15. The computing program for designing a semiconductor integrated circuit according to claim 14, wherein;
said second layout correcting step comprises;
a margin-determining step of determining the margin of said holding time on the basis of said second layout patern,
a holding time computing step of computing the computation value of said holding time, and
a holding time violation detecting step of detecting a holding time violation of said second layout patern on the basis of said computation value and said margin.
